(19) United States
(12) Patent Application Publication
(10) Pub. No.: US 2013/0025146 A1
(43) Pub. Date: Jan. 31, 2013

(54) DS speed marker

(71) Applicant: Dan Spallino, Fort Jones, CA (US)

(72) Inventor: Dan Spallino, Fort Jones, CA (US)

(21) Appl. No.: 13/136,094

(22) Filed: Jul. 25, 2011

(51) Int. Cl. B25H 7/04

(52) U.S. Cl. 33/666

(57) ABSTRACT

The DS SPEED MARKER was developed as a measuring device. The handle is comfortable in size and length and the revolution of the wheel creating a chalk mark upon each revolution is effortless to use. I have used the DS SPEED MARKER countless times in the field. It is well made, very durable, accurate and the most efficient way to measure and mark lengths of firewood available.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The DS SPEED MARKER is designed to be used in the outside environment. It is considered a measuring device, and its purpose is to accurately mark a log into lengths for firewood in the most efficient manner possible. This enables the next stage of actually cutting a log into consistent lengths.

### BRIEF SUMMARY OF THE INVENTION

The purpose of the DS SPEED MARKER is to expedite the process of cutting a log(s) into equal lengths of firewood without the having to utilize multiple tools to do so. There is no need for a measuring tape, spray paint, or a lumber crayon/marker. It is an environmentally friendly product using biodegradable chalk. The DS SPEED MARKER is an extremely efficient tool to utilize.

### BRIEF DESCRIPTION OF THE SEVERAL VIEWS OF THE DRAWING

FIG. 1A: is an exploded view of all components that make up the DS SPEED MARKER.

FIG. 1B: shows the wheel completely assembled with the axle in place prior to fastening the handle.

FIG. 1C: shows the wheel and handle assembly prior to being fastened together.

FIG. 1D: shows the DS SPEED MARKER completely assembled.

FIG. 2: shows the DS SPEED MARKER with the Velcro loops rolled back exposing the chalk cavity.

FIG. 3: shows the DS SPEED MARKER with the Velcro loops sealing the chalk cavity.

FIG. 4: is intended to highlight the flat portion of the wheel where the chalk cavity is located.

FIG. 5A: identifies the three individual members which make up the wheel prior to assembly.

FIG. 5B: shows (1b) and (1c) fastened together prior to fastening (1a) revealing what is to be the chalk cavity in the center of the wheel.

FIG. 5C: show the three members that make up the wheel (1a, 1b, 1c) fastened together prior to adhering the coarse grip tape the edge of the wheel.

FIG. 5D: shows the wheel completed.

FIG. 6: specific detailing of (1a).

FIG. 7: specific detailing of (1b).

FIG. 8: specific detailing of (1c).

FIG. 9: specific detailing of handle (2).

FIG. 10: view of the handle (2).

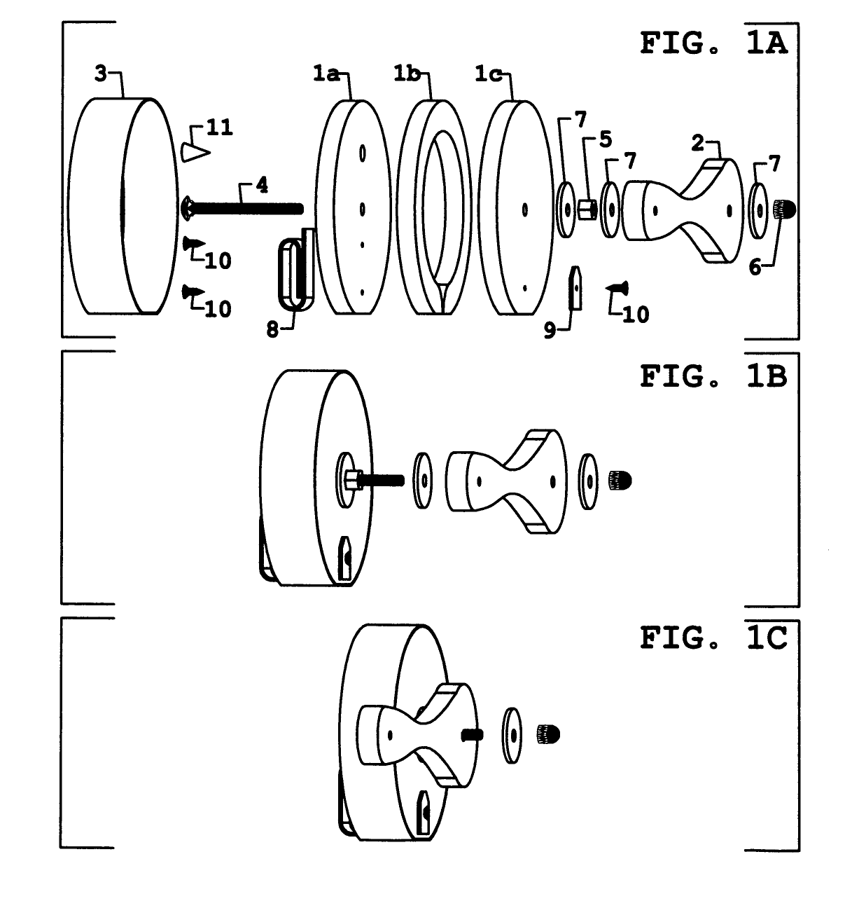

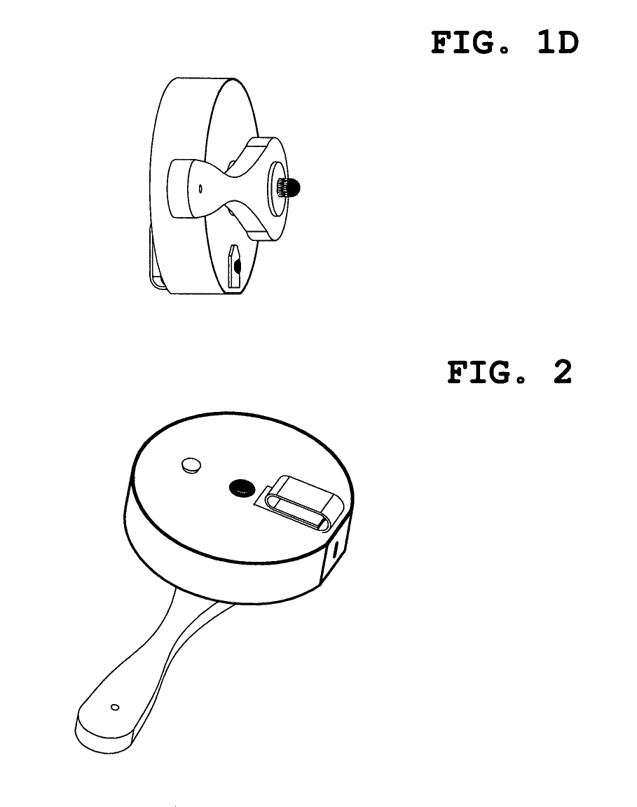

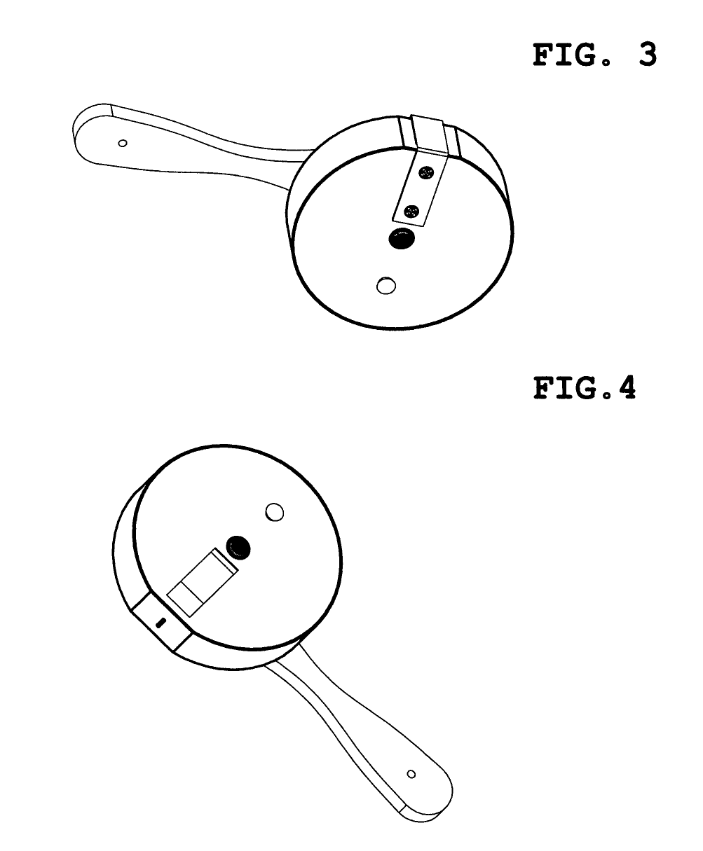

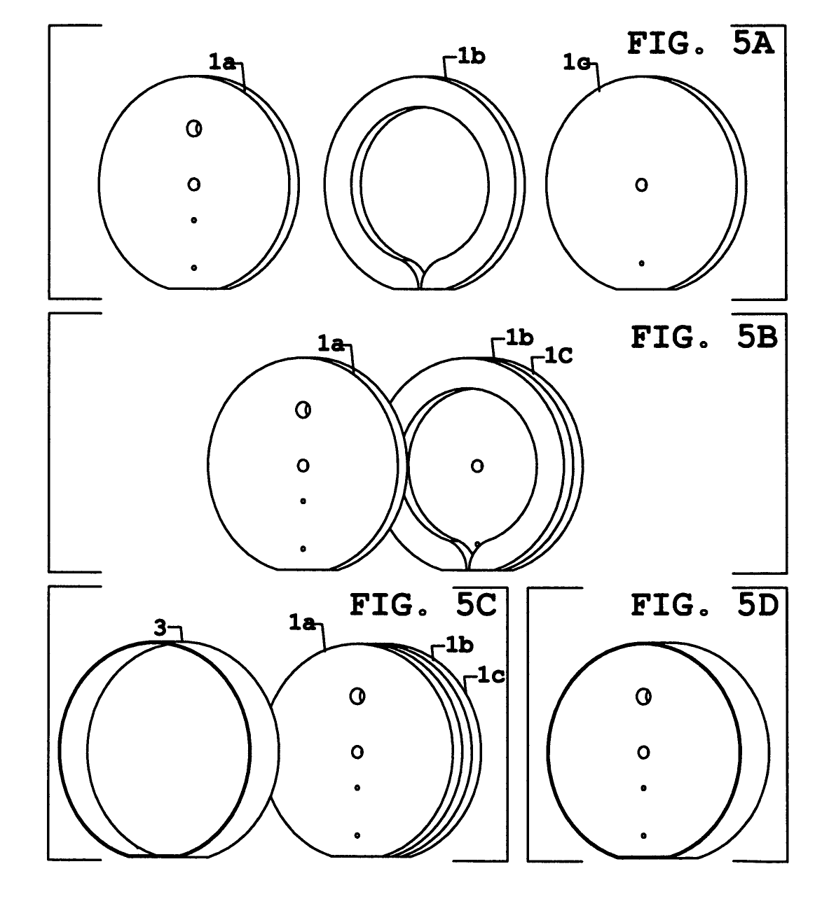

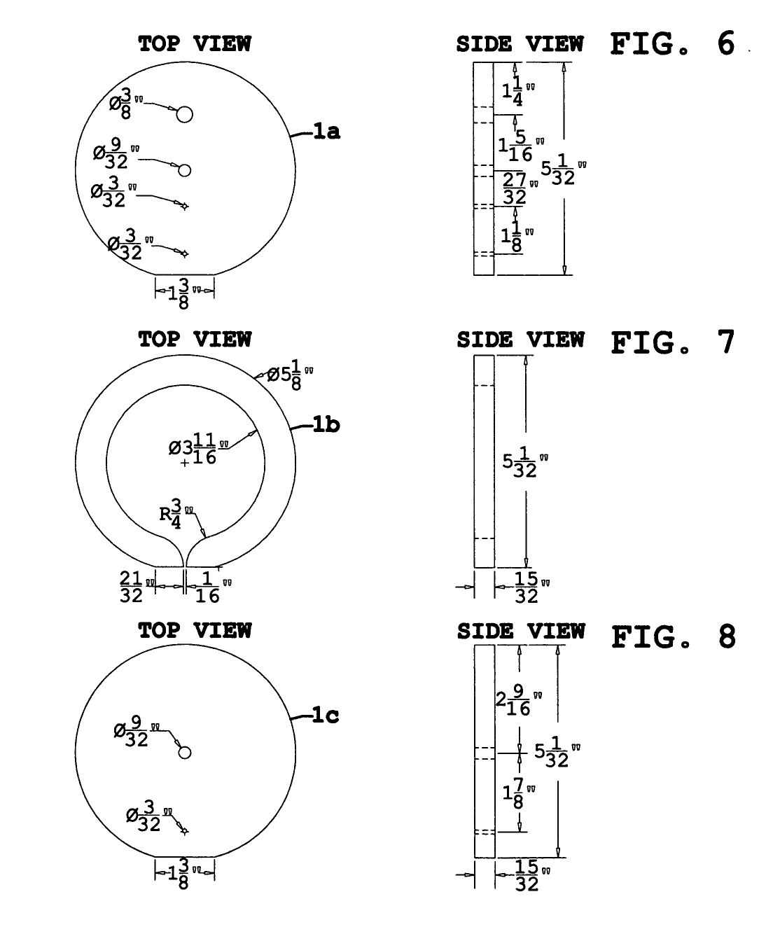

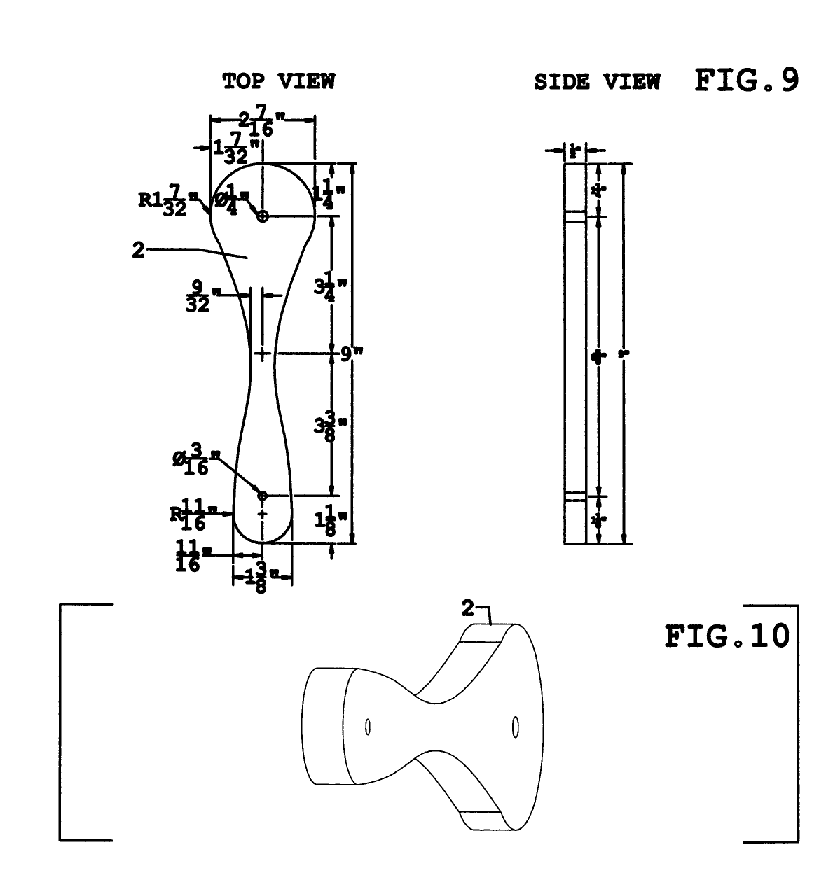

### DETAILED DESCRIPTION OF THE INVENTION

DS SPEED MARKER was designed to mark a log (fallen tree) into equal lengths of firewood to be cut.

The DS Speed Marker is made from three different pieces of maple plywood (1a), (1b), (1c) which together create a wheel. These pieces are glued then nailed together using 18 gauge 1″ brad nails from both sides. Once joined together, 1b creates a hollow cavity and an outlet within the wheel.

The wheel (1a, 1b, 1c) is then filled with colored marking chalk through the hole which is plugged by self-sealing rubber plug (11). The chalk outlet located at the flat portion of the radius of the wheel, is sealed with the Velcro loops (8) to the Velcro hooks (9).

The wheel (1a, 1b, 1c) has a coarse self-adhesive grip (3), also with a chalk outlet, fastened to the edge of the entire wheel which creates friction, or grip, between the wheel and the contact surface allowing for an effortless rotation of the wheel.

The wheel (1a, 1b, 1c) is fastened to the maple handle (2) with the carriage bolt/axle (4), fender washers (7), nylon lock nut (5), and acorn nut (6).

The 5⅛″ diameter wheel is color coded bright orange and creates a chalk mark every 16″.

To use the DS SPEED MARKER simply roll the Velcro loops (8) over onto its own Velcro hooks exposing the chalk outlet. Place the flat portion of the wheel with the chalk outlet on the end of a log. Keep constant contact between the wheel and the surface of the log. While holding the handle, and giving a forward motion, begin walking next to the log. Every full rotation will cause an impact between the flat portion of the wheel and contact with the log forcing chalk from the outlet onto the log, creating equally spaced chalk marks down the length of the log.

Available options to this size wheel are: a 4⅞″ diameter color coded bright yellow and creates a chalk mark every 15½″. A 4⅝″ diameter color coded bright green and creates a chalk mark every 15″. All wheels utilize the same hardware and layout as the 5⅛″ diameter. All wheels and hardware are fully interchangeable with a handle, the only variation between all wheels are the diameter itself.

1. What I claim as my invention is the DS SPEED MARKER is specifically designed to mark a log (fallen tree) into consistently equal lengths of measurement in the most efficient effortless way possible. Thus enabling the marked lengths to be cut into equal pieces.
